(19) United States
(12) Patent Application Publication
(10) Pub. No.: US 2002/0183412 A1
(43) Pub. Date: Dec. 5, 2002

(54) Silane crosslinking process

(75) Inventors: Ali Harlin, Vantaa (FI); Matti Sistola, Helsinki (FI)

Correspondence Address: OLIFF & BERRIDGE, PLC, P.O. BOX 19928, ALEXANDRIA, VA, 22320, US

(73) Assignee: MAILLEFER S.A.., Ecublens (CH)

(21) Appl. No.: 10/133,411

(22) Filed: Apr. 29, 2002

Related U.S. Application Data
(63) Continuation of application No. PCT/FI00/01018, filed on Nov. 23, 2000.

(30) Foreign Application Priority Data
Nov. 24, 1999 (FI) 19992506

(51) Int. Cl. C08J 3/28; C08F 255/00

(52) U.S. Cl. 522/60; 525/263; 525/288; 522/120; 522/114

(57) ABSTRACT

The invention relates to a process of crosslinking a polymer material with silane by means of heat, in which process a polymer, a grafting agent, an initiator and a crosslinking catalyst and optional additives are fed into an extruder and extruded to a homogenous mass by keeping the process temperature so low that the initiator used does not degrade during the extrusion and the optional additives do not react or degrade in the extruder, and, after the extrusion, the extruded mass is grafted and crosslinked. After the extrusion, the process of the invention comprises a step of heating the initiator, mixed homogenously with the polymer material, by means of infared radiation in a wavelength range absorbed by the initiator.

The invention relates to a process of crosslinking a polymer material with silane by means of infrared radiation.

It is known to change the properties of polymer materials by means of various additives. In some cases, the desired changes in the properties of polymer materials, such as the modification of the properties of polyethylene and other polyolefins by crosslinking, are subject to the additive being chemically disintegrated by means of heat. A typical example of such an additive is a chemical crosslinking agent, such as peroxide. In this case, the crosslinking agent itself is added in a separate compounding process or during the manufacture of the plastic product, and it is disintegrated by means of heat immediately after the mechanical working process.

Polymers, such as polyethylene, are also known to be crosslinked by the use of a peroxide initiator, a hydrolysing silane compound and a condensation catalyst, as taught in U.S. Pat. No. 3,646,155 and 4,117,195. Said process can be carried out by feeding into an extruder and extruding a polyethylene, a peroxide, e.g. dicumyl peroxide, a silane compound, e.g. vinyltrimethoxysilane or vinyltriethoxysilane, and a condensation catalyst, e.g. dibutyltin dilaureate, yielding a grafted product, which is then processed under condensation conditions in the presence of water or steam to obtain a crosslinked product.

A well-known process of crosslinking the insulation of an energy cable is to crosslink a peroxide-containing material in a vulcanization tube using either steam or thermal radiation. The vulcanization process based on thermal radiation is carried out in an inert gas atmosphere at an elevated pressure, typically in a nitrogen atmosphere at a pressure of 6 to 10 bar.

The disadvantage of crosslinking by means of steam is that the polymer material used as the insulating material reaches water equilibrium and its water content can be up to 2,000 to 3,000 ppm after the processing. The high water content of the insulating material significantly increases the formation of what are known as water trees in the insulating material when the insulating material is in an electric field.

Dry crosslinking is based on a heated tube typically having a wall temperature of 250 to 450° C. The temperatures used are so low that the thermal radiation has a long wavelength and the radiation is able to heat only the outer surface of the insulation. This slows down the crosslinking speed, and, at the same time, high local temperatures may destroy the outer surface because of the thermal degradation of the polymer. However, the risk of the formation of water trees is substantially lower than in crosslinking with steam.

Crosslinking may also be carried out in salt melt or by using a long die lubricated with silane oil. Both processes are limited by a slow crosslinking speed, owing to the maximum temperatures of use of salt melts and silane oils. In these processes, heat transmission is based on convection.

The above processes require expensive pressure vessels to control the high pressure. Overpressure is needed to avoid the formation of bubbles generated by gaseous breakdown products of the peroxide in the insulating material. Difficulties associated with starting and stopping are disadvantages in the overpressure process. It is also to be noted that the use of overpressure in the process increases the safety risk.

In a silane crosslinking process, curing takes place only after the extrusion by hydrolysis of the silane compounds grafted onto the polymer. The most significant advantage achieved with the silane crosslinking process is the chance to use simple extrusion lines at normal atmospheric pressure. The starting and stopping of the process are also markedly simpler.

Problems are often associated with known processes when the aim is homogenous product quality and an economical and simple process. Such problems are especially common in a continuous process. For example, when insulations are made for cables and conductors by a continuous crosslinking process, the production line being long, the result may be a product that cannot be used because of uneven quality. Here, economic losses may also be high. To achieve a product having a uniform quality is very important particularly in the manufacture of insulations for cables and conductors. This naturally applies also to the manufacture of other products, such as tubes, when a continuous process and a long production line are used.

The chemical disintegration of the above additives is conventionally achieved by heating the entire polymer material to a temperature at which sufficient degradation of the additive takes place. In practice, the heating can take place either immediately after the manufacture of the polymer product in line or as a separate process.

A typical example of chemical disintegration in line is the manufacture of crosslinked insulations for cables or conductors. For this purpose, several processes have been developed, such as Monosil, Sioplas (U.S. Pat. No. 3,646,155) and Dry silan (U.S. Pat. No. 5,112,919). In these processes, the entire polymer material is typically heated at the grafting stage in an extruder to a temperature at which the degradation of peroxide is sufficient.

The Sioplas process involves two steps. In the first step, a polymer, silane and peroxide are fed into an extruder, mixed and melted into a homogenous mass. In the extruder, the temperature of the entire mass is raised to the degradation temperature of the peroxide, resulting in a grafted mass, which is extruded into tape and granulated. In the second step, the grafted mass and the mixture of the polymer and the condensation catalyst are fed into an extruder and a product is extruded from the mass. The obtained product is crosslinked after the extrusion in hot water, steam or moist air.

The Monosil process comprises feeding a polymer, silane, peroxide and a condensation catalyst into a long extruder and extruding the product in one process step. In the first zone of the extruder, in the mixing step, the temperature is sufficiently low to prevent premature degradation of the peroxide and grafting of the material. After the extrusion, the grafted product is crosslinked as in the above-described Sioplas process.

The Dry silan process, corresponding to the Monosil process, differs from the above described only in that said silane is absorbed into a porous carrier material, making its mixing into the polymer granulates easier than into liquid silane. This also avoids any lowering of the production speed in the metering zone due to the intermittent friction between the material being metered and the wall of the extruder.

Long-term properties of insulations have a significant relevance in cables and conductors. In the above processes, the entire polymer material is heated to a temperature at which sufficiently peroxide is degraded. Herein, the problem is the poor thermal conductivity of the polymer material. The heating time has to be long in order for the heat to have time to be transferred via the outer surface of the cable or conductor to the entire width of the wall. The same problem is present in the manufacture of tubes. Such extreme heating of a polymer material makes the high temperature cause aging in the molecular structure of the polymer, resulting in impaired long-term properties in the product. This disadvantage can be alleviated by the generation of an inert gas phase around the product during the heating, but in any case, some free oxygen is always present in the plastic structure and it causes aging together with the heat. In addition to oxidative degradation, spontaneous thermal degradation also occurs in plastic at high temperatures.

Different solutions have been suggested to the degradation of a polymer material owing to the above-described heating of the material. WO97/10936 teaches a process of heating a polymer material by means of infrared radiation. The process is based on the use of such wavelengths of infrared radiation that are not substantially absorbed by the polymer material, i.e. wavelengths for which the polymer has absorption peaks are filtered off from the IR radiation in manners known per se. The object is to heat the entire polymer material at the crosslinking stage uniformly across the entire thickness thereof to the degradation temperature of peroxide. Consequently, the process of WO97/10936 avoids local peak temperatures during heating.

The disadvantage of the process disclosed in WO97/10936 is that the entire polymer material still has to be heated to the degradation temperature of the additive. This causes considerable energy costs both at the heating and cooling stages.

It has now been found that the above disadvantages can be avoided by heating only the peroxide, homogenously mixed with the polymer material, at the crosslinking stage, instead of the entire polymer material. Peroxide can be heated by means of infrared radiation by using wavelengths that absorb substantially only into the peroxide used. The process allows the use of distinctly lower material temperatures during extrusion, which, in turn, ensures that during the extrusion the peroxide does not substantially degrade, i.e. grafting can be carried out after the extrusion and only the peroxide need to be heated in the grafting. The process substantially saves energy, since instead of the entire polymer material, only the peroxide is heated, its content being only about 0.2% by weight of the amount of material. Owing to the lower process temperatures, the need for cooling is also smaller, which saves costs and simplifies the process.

The present invention relates to a process of crosslinking a polymer material by means of heat, in which process a polymer, a grafting agent, an initiator and a crosslinking catalyst and optional additives are fed into an extruder and extruded to a homogenous mass by keeping the process temperature so low that the initiator used does not degrade during the extrusion and the optional additives do not react or degrade in the extruder, and, after the extrusion, the process comprises a step of heating the extruded mass by means of infrared radiation in order to graft and crosslink the extruded mass. The process is characterized by the heating being performed by means of infrared radiation in a wavelength range that is absorbed substantially only by the initiator used.

In an embodiment of the invention, the process comprises a step of releasing the crystal water constituting the blend component of the material from its carrier by means of infrared radiation that absorbs into a selected agent.

Furthermore, in an embodiment of the invention, the process comprises a step of disintegrating the optional additive constituting the blend component of the material by heating it by means of infrared radiation that absorbs into a selected agent.

In addition, in an embodiment of the invention, the process comprises a step of removing any tensions remaining in the product at the manufacturing stage by sufficiently heating the end product by means of infrared radiation by using a wavelength of infrared radiation that absorbs into the polymer material.

The process of the invention uses one or more infrared sources for crosslinking a polymer material with silane. These infrared sources ensure a controlled reaction, either simultaneously or separately, of the substances required by both the grafting and the crosslinking. The different substances in the polymer material can be affected selectively by changing the wavelength of the infrared radiation. This can be accomplished simply by changing the intensity of the current passing through the radiation source, thus changing the temperature of the radiation source. Such an arrangement facilitates the adjustment of the grafting and allows the different reactions to be adjusted and initiated independently.

As crosslinking composition is used an olefinic polymer, preferably polyethylene, having 0.2 to 2.5% by weight, preferably 0.2 to 0.7% by weight, of dicumyl peroxide or di-tert-butyl peroxide and 0.5 to 3.0% by weight of vinyltrimethoxysilane or vinyltriethoxysilane, and as crosslinking catalyst dibutyltin dilaureate. An insufficient feed of reactants results in imperfect crosslinking, and excessive feed of reactants impairs the quality of the surface of the product.

Crosslinking is suitably carried out in one step either by releasing water from a compound containing crystal water and mixed with the polymer mass or in a steam tube process. In the process of the invention, the polymer material may contain a water releasing substance, such as aluminium hydroxide or caprolactam novolac, preferably 0.5 to 2% by weight. Crosslinking requires an amount corresponding to a water release of about more than 500 ppm.

An infrared radiation wavelength suitable for the chemical disintegration of peroxide is about 1.2 μm, which efficiently penetrates polyethylene, for example, but heaths the peroxide molecules. This wavelength absorbs particularly into peroxide, but not into polyethylene, i.e. the infrared radiation wavelengths substantially between 3.3 to 3.6 μm and 6.7 to 6.9 μm are absorbed. In other words, the use of an infrared radiation wavelength characteristic of peroxide in particular, allows the heating of the surrounding polymer material to be minimized.

The wavelength of the radiation transmitted by the infrared source can also be adjusted with different filters, such as absorbers or reflectors, in front of the infrared source. Such filters are needed particularly when the wavelength range of the radiation has to be narrowed down. This is necessary for example when the radiation absorption peaks of two reactive components are very close to one another.

The infrared source used in the process of the invention can be placed immediately after the crosshead of the extruder. The advantage here is that the infrared radiation easily penetrates the melt polymer material and the effectiveness of the process can thus be maximized. This also renders the reaction step independent of the extrusion process.

Infrared sources can be alternatively placed in succession as required before the cooling steps and/or between the cooling steps. A suitable placement of the infrared sources also allows the temperature of the polymer material to be controlled during the process. This is particularly important when such polymeric materials are used that include additives and are characterized by overheating of the surface.

Between the infrared sources the temperature can be measured for example by infrared measurement. Similarly, the composition of the polymer material can also be observed by means of infrared.

An individual infrared source may comprise three or more radiators that are placed evenly around the polymer material to be radiated. This ensures even radiation of the material from all sides.

The polymer composition to be crosslinked is extruded at a temperature lower than the degradation temperature of the peroxide used. If low-density polyethylene is used as the polymer, its melt temperature in the extruder is preferably in the range 120 to 180° C., more preferably in the range 135 to 150° C., most preferably in the range 135 to 140° C.

Alternatively, a water-releasing agent can be added in the extrusion step, whereby, owing to the low temperature during the extrusion, the agent does not react until after the extrusion.

The polymer material preferably contains less than 5% by weight of carbon black, calculated from the entire weight of the polymer material, since the penetrating power of infrared radiation weakens because of the addition of the carbon black. The absorption peaks of organic dyes are usually in the wavelength range 3 to 5 μm, so they do not harm the chemical disintegration of the additives used in the process of the invention. Inorganic dyes, in contrast, are comparable with carbon black and impair the penetrating power of infrared radiation.

If a polymer material containing abundantly inorganic filler, such as halogen-free fire-resistant material, is used in the process of the invention, the material can be extruded at an elevated temperature. In this case, part of the grafting takes place in the extruder, but the grafting is finished after the extruder. The temperature in the extrusion of fire-resistant materials is preferably between 180 and 210° C., depending on the composition of the material used.

### EXAMPLES

Cable samples were extruded with a 120-mm extruder having a length of 24D. The screw installed was a simple Maddock screw for a smooth barrel. The crosshead used was of the single-layer type, whose maximum conductor inlet size was 35 mm (cross-sectional area 800 mm²) and maximum cable outlet size 45 mm (insulation 5 mm or 10 kV).

The temperature profile was as follows: 60° C. in the first zone, and 120° C. in the last five zones, the adapter and the crosshead. The melt temperature in the crosshead was <130° C. The conductor used was of solid aluminium and had a cross-sectional area of 185 mm². The tools used in the extruder were tube type having the following dimensions: tip 16.5 mm and mandrel 18 mm and 24 mm.

The cable was introduced into an IR source after the crosshead in accordance with the steps presented in the examples. When specifically mentioned, several heating cycles and intermediate cooling were used between the IR radiation steps.

### Examples 1 to 3

Examples 1 to 3 used a commercially available LDPE polymer having a melt flow rate (MFR) of 2.0 g/10 min measured with a 2.16-kg weight, and a density of 922 kg/m³. In the metering zone of the extruder, a 1.8% silane composition containing 73% by weight of vinyltrimethoxysilane, 1% by weight of dibutyltin dilaureate and 24% by weight of dicumyl peroxide were added to the polymer. The cable samples were heated in boiling water for 4 hours before the Hot Set value was measured.

| Example | Time, s | P, kW | T_{insulation,maximum}, ° C. | Hot Set, % |
|---|---|---|---|---|
| 1 (99080608) | 3 × 10 | 12 | 182 | 113 |
| 2 (99080809) | 2 × 10 | 12 | 186 | 105 |
| | 4 × 10 | 6 | | |
| 3 (99080610) | 2 × 10 | 12 | 180 | 130 |
| | 4 × 10 | 6 | | |

### Example 4

Step 1

A silane-grafted polyethylene compound was extruded onto a conductor at a temperature of 135 to 140° C. The polymer part of the polyethylene compound contained an antioxidant and a hydrolysis catalyst. The polyethylene compound further contained vermiculite for releasing 2,000 ppm (=0.2% by weight calculated from the weight of the compound) of water in the second step.

The amount of vermiculite required was calculated on the basis of an experiment performed, according to which vermiculite releases about 3.0% by weight of water when heated from 135° C. to 260° C. Thus, the amount of vermiculite required, calculated from the weight of the compound is: 100% (0.002/0.03)=6.7%.

After the extrusion, the temperature of the isolation was raised to 250 to 260° C. using an infrared source.

Step 2

The temperature of the isolation was raised to 260 to 280° C. using an infrared source.

### Example 5

The experiment was carried out as described in example 4, except that aluminium trihydroxide (ATH) instead of vermiculite was used as the water-releasing compound. When heated from 135° C. to 260° C., ATH releases about 33% by weight of water. Thus the amount of ATH required, calculated from the weight of the compound is: 100% (0.002/0.33)=0.6%.

### Example 6

The experiment was carried out as described in example 4, except that instead of a water-releasing compound, the reaction of an equimolar mixture of adipic acid and 1.6-diaminohexane at 260 to 280° C. was used to release water. This reaction leads to the synthesis of poly(hexamethyleneadipamide), which is known to release water. The required amount of water, i.e. 0.2% by weight calculated from the weight of the compound, is obtained by the addition of 0.65% of 1,6-diaminohexane and 0.8% of adipic acid to a compound that is extruded onto a conductor at a temperature of 150° C.

1. A process of crosslinking a polymer material with silane by means of infrared radiation, in which process a polymer, a grafting agent, an initiator and a crosslinking catalyst and optional additives are fed into an extruder and extruded to a homogenous mass by keeping the process temperature so low that the initiator used does not degrade during the extrusion and the optional additives do not react or degrade in the extruder, and, after the extrusion, the process comprises a step of exposing the extruded mass to infrared radiation in order to graft and crosslink the extruded mass, characterized by utilizing the infrared radiation in a wavelength range that is absorbed substantially only by the initiator used.

2. A process as claimed in claim 1, characterized by comprising a step of releasing the crystal water constituting the blend component of the material from its carrier by means of infrared radiation that absorbs into a selected agent.

3. A process as claimed in claim 1 or 2, characterized by comprising a step of degrading the optional additive constituting the blend component of the material by heating it by means of infrared radiation that absorbs into a selected agent.

4. A process as claimed in any one of claims 1 to 3, characterized by comprising a step of removing any tensions remaining in the product at the manufacturing stage by heating the finished product sufficiently by means of infrared radiation, using a wavelength of infrared radiation that absorbs into polymer material.

5. A process as claimed in any one of claims 1 to 4, characterized in that the grafting agent used is a silane compound.

6. A process as claimed in any one of claims 1 to 5, characterized in that the silane compound used is vinyltrimethoxysilane or vinyltriethoxysilane.

7. A process as claimed in any one of claims 1 to 6, characterized in that the initiator used is peroxide.

8. A process as claimed in any one of claims 1 to 7, characterized in that the peroxide used is dicumyl peroxide or di-tert-isobutyl peroxide.

9. A process as claimed in any one of claims 1 to 8, characterized in that the polymer used is polyethylene.

10. A process as claimed in any one of claims 1 to 9, characterized in that the crosslinking catalyst used is dibutyltin dilaureate.

11. A process as claimed in any one of claims 1 to 10, characterized in that the crosslinked product is the insulation of a cable or an insulator.
